(19) United States
(12) Patent Application Publication
(10) Pub. No.: US 2013/0325590 A1
(43) Pub. Date: Dec. 5, 2013

(54) CENTRALIZED AND AGGREGATED TRACKING IN ONLINE ADVERTISING PERFORMANCE PREDICTION

(71) Applicants: Ajay SHEKHAWAT, San Francisco, CA (US); Eren Manavoglu, Menlo Park, CA (US)

(72) Inventors: Ajay SHEKHAWAT, San Francisco, CA (US); Eren Manavoglu, Menlo Park, CA (US)

(73) Assignee: Yahoo! Inc., Sunnyvale, CA (US)

(21) Appl. No.: 13/485,532

(22) Filed: May 31, 2012

(51) Int. Cl. G06Q 30/02

(52) U.S. Cl. 705/14.43

(57) ABSTRACT

The present invention provided techniques that may be used, for example, in online advertising. Techniques are provided that include centralized and aggregated advertisement performance data tracking, which can be used in advertisement selection. Advertisement performance data may be obtained by a central server, such as from many advertisement servers. The central server may aggregate the performance data, and may generate a performance snapshot spanning many advertisements. The snapshot may be used in generating a performance prediction model, which may in turn be used in advertisement selection, or monitoring or tracking associated with advertising. Elements or actions, such as obtaining of performance data, aggregation, generation of the snapshot, and generation of the model, may include frequent or real time updating of such elements or actions.

### BACKGROUND

Techniques such as advertisement performance prediction, such as click through rate, or CTR prediction, for example, are used in online advertising, such as, for example, in ad selection, placement or ranking, as well as monitoring and reporting. However, existing techniques can suffer from problems such as being inefficient, slow, cumbersome, fragmented, or lagging in data freshness or update frequency, for example.

### SUMMARY

Some embodiments of the invention provide systems and methods that may be used, for example, in online advertising. Techniques are provided that include centralized and aggregated advertisement performance data tracking, which can include, for example, click or conversion tracking, budget or spending tracking, or simultaneous or concurrent tracking of these and other types or data, which can be used in advertisement selection, placement or ranking, or in monitoring or reporting associated with the data. Advertisement performance data may be obtained by a central server, such as from many advertisement servers. The central server may aggregate the performance data, and may generate a performance snapshot spanning many advertisements. The snapshot may be used in generating a performance prediction model, which may in turn be used in advertisement selection, placement or ranking, or in monitoring or reporting. Elements or actions, such as obtaining of performance data, aggregation, generation of the snapshot, and generation of the model, may include frequent or real time updating of such elements or actions.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

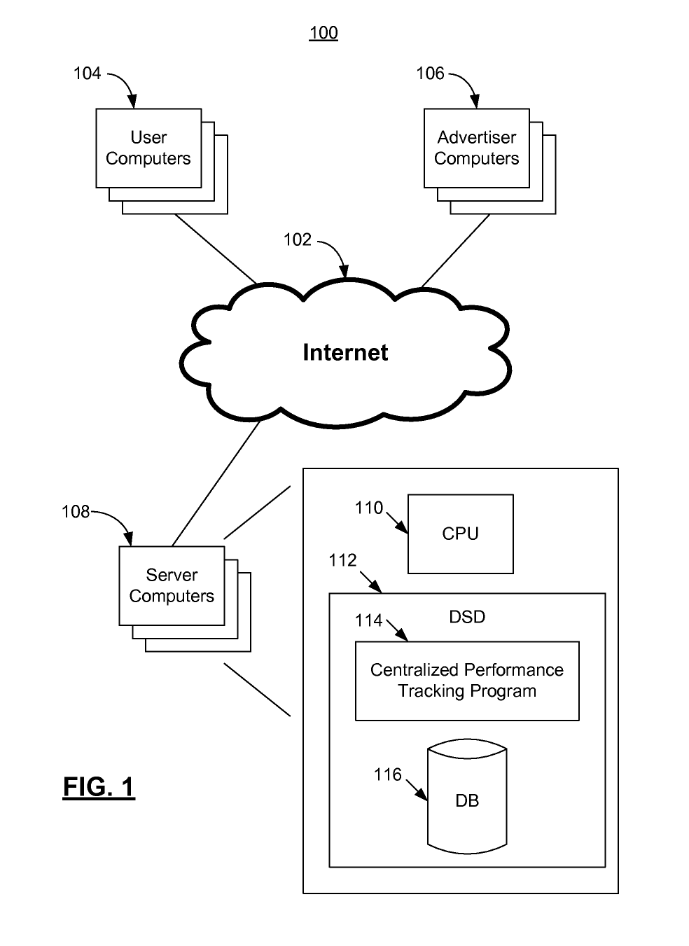

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, smart phone, PDAs, tablets, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, coupon-related advertisements, group-related advertisements, social networking-related advertisements, etc.

As depicted, each of the server computers 108 includes one or more CPUs 110 and a data storage device 112. The data storage device 112 includes a database 116 and a Centralized Performance Tracking Program 114.

Herein, the term “centralized” is used broadly. A centralized computer can include, for example, any computer that obtains data from more than one external source, external computers, or distributed computers. Furthermore, herein, a centralized server computer can be or include a number of architecturally, conceptually, or physically, separate or distributed server computers, such as may be integrated or facilitated using techniques such as sharding.

Herein, performance data can include, among other things, data such as ad impression data, click through or click through rate data, action or user action data, metrics, etc. Performance data can further include other types of data used in assessing ad or ad campaign performance, such as advertisement, advertiser or ad campaign budget data, spend data, etc.

It is to be noted that, according to some embodiments, performance data tracking can include tracking of various types of information, including concurrent, integrated or simultaneous tracking. This can include, for example, click or conversion tracking, budget or spend tracking, simultaneous tracking or both of these and potentially other types of data,

The Program 114 is intended to broadly include all programming, applications, algorithms, software, engines, modules, functions, and other tools necessary to implement or facilitate methods and systems according to embodiments of the invention. The elements of the Program 114 may exist on a single server computer or be distributed among multiple computers or devices.

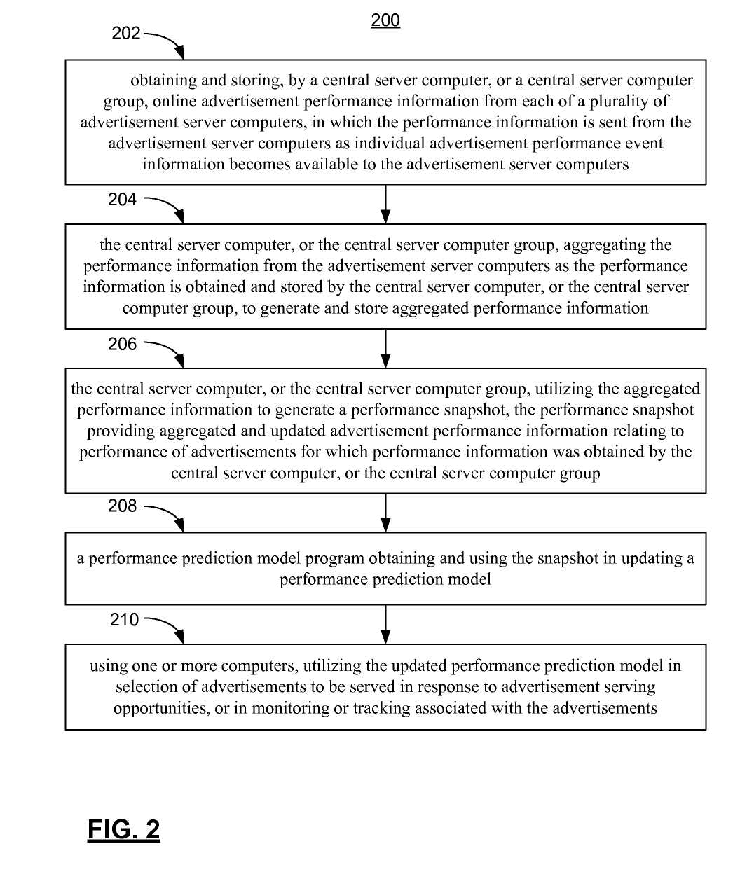

FIG. 2 is a flow diagram illustrating a method 200 according to one embodiment of the invention.

Step 202 includes obtaining and storing, by a central server computer, or a central server computer group, online advertisement performance information from each of a plurality of advertisement server computers, in which the performance information is sent from the advertisement server computers as individual advertisement performance event information becomes available to the advertisement server computers.

Step 204 includes the central server computer, or the central server computer group, aggregating the performance information from the advertisement server computers as the performance information is obtained and stored by the central server computer, or the central server computer group, to generate and store aggregated performance information.

Step 206 includes the central server computer, or the central server computer group, utilizing the aggregated performance information to generate a performance snapshot, the performance snapshot providing aggregated and updated advertisement performance information relating to performance of advertisements for which performance information was obtained by the central server computer, or the central server computer group.

Step 208 includes a performance prediction model program obtaining and using the snapshot in updating a performance prediction model.

Step 210 includes, using one or more computers, utilizing the updated performance prediction model in selection of advertisements to be served in response to advertisement serving opportunities, or in monitoring or reporting associated with the advertisements.

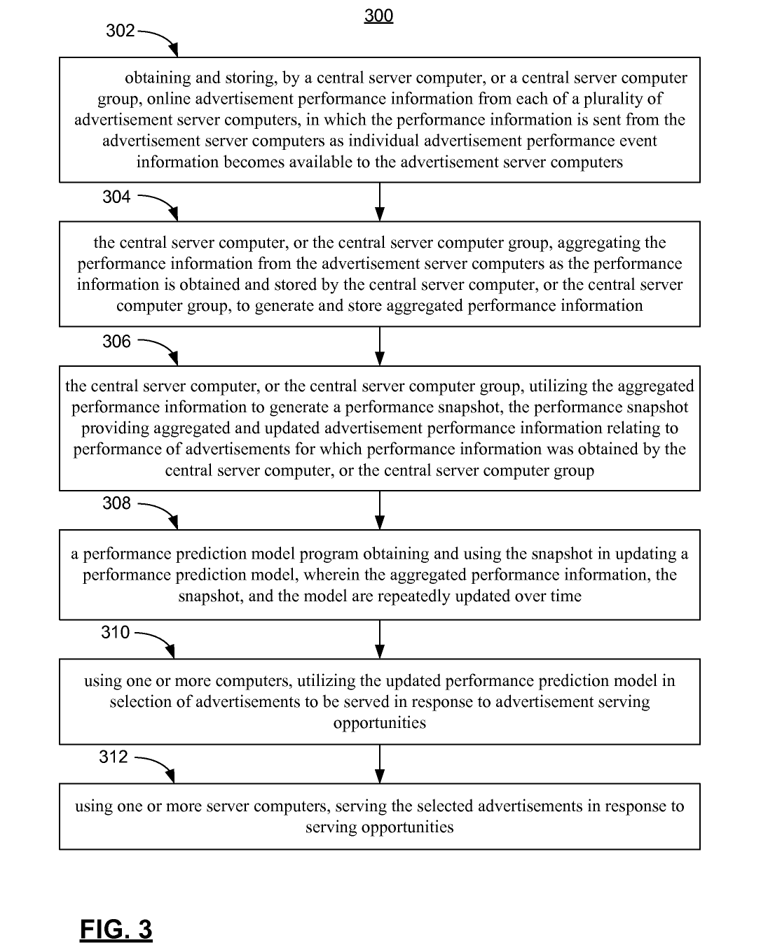

FIG. 3 is a flow diagram illustrating a method 300 according to one embodiment of the invention.

Steps 302-306 are similar to steps 202-206 as depicted in FIG. 2.

Step 308 includes a performance prediction model program obtaining and using the snapshot in updating a performance prediction model, wherein the aggregated performance information, the snapshot, and the model are repeatedly updated over time.

Step 310 includes, using one or more computers, utilizing the updated performance prediction model in selection of advertisements to be served in response to advertisement serving opportunities.

Step 312 includes, using one or more server computers, serving the selected advertisements in response to serving opportunities.

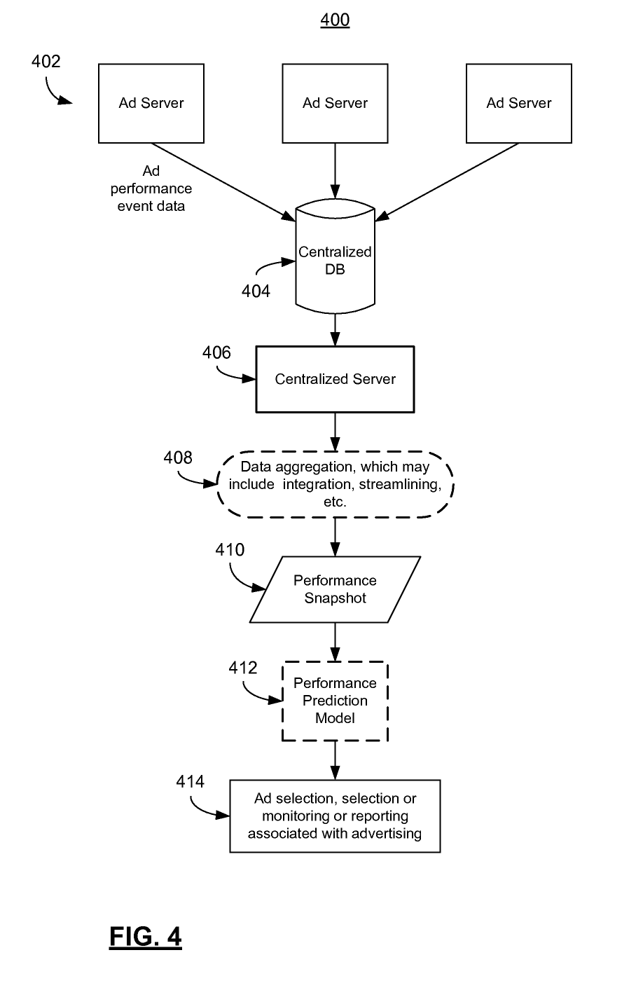

FIG. 4 is a block diagram 400 illustrating one embodiment of the invention. As depicted, ad performance event data is sent from multiple ad servers 402 to be stored in a centralized database 404. The data may be sent directly from the ad servers 402 to the centralized database 404, or a centralized server 406, or may be sent from the ad servers 402 to one or more intermediary computers, locations, sources, etc., and ultimately obtained by the centralized database 404, or a centralized server 406. Furthermore, the database 404 may be part of a centralized server 406, or may be separate.

As depicted, performance data is sent from the centralized database 404 to the centralized server 406. However, in some embodiments, the performance data may be obtained by a centralized server directly, or by a database of a centralized server directly.

Block 408 represents aggregation of the performance data. Such aggregation can include merging as well as various other actions, such as integration, reduction, streamlining, rearranging, manipulating, etc. Aggregation may include actions on data in order to generate a snapshot, or in order to generate an efficiently or optimally fashioned snapshot for use, for example, by a performance prediction model.

Block 410 represents a generated performance snapshot.

Block 412 represents a performance prediction model, which utilizes an obtained performance snapshot 410.

Block 414 represents, using the performance prediction model 412, Ad selection, ad serving, or monitoring or tracking associated with advertising, or any combination of the foregoing. Such monitoring or tracking can include, for example, click or conversion tracking, budget or spending tracking, or simultaneous or concurrent tracking of these and other types or data, which may, for example, be used in advertisement selection, placement or ranking, or in monitoring or reporting associated with the data.

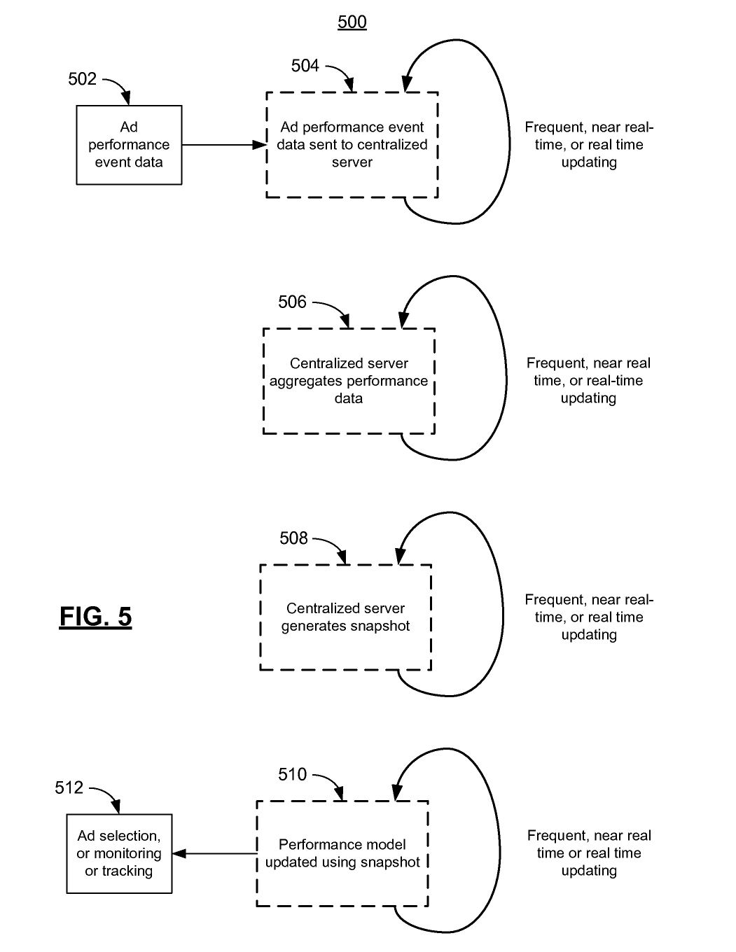

As described further in connection with FIG. 5, for example, various elements may be updated on a frequent, near real time or real time basis, which can include the sending of performance data to, or obtaining of the performance data by, a centralized server or centralized database, the aggregation, the snapshot, and the performance prediction model. Herein, a performance prediction model can include elements such as a performance prediction model program, which program may be used in updating a model, such as a feature-based or machine learning based model.

FIG. 5 is a block diagram 500 illustrating one embodiment of the invention. Specifically, FIG. 5 depicts a number of elements that may be updated, such as continuously, repeatedly or periodically updated, frequently, in near-real time or real time, such as in seconds or fractions of a second, for example. Particularly, FIG. 5 depicts elements that are updated frequently, in near real time, or in real time, including sending of ad performance event data 502 to a centralized server 504, or obtaining of such data by such a server, aggregation of performance data 506, snapshot generation 508, and performance model updating 510. Block 502 represents performance data sent to, or obtained by, a centralized server, such as frequently or in near real time sent or obtained by the centralized server, and block 512 represents ad selection, or monitoring or tracking associated with advertising, which can include an advertising campaign, using a frequently, in near real time, or in real time updated performance model.

In a distributed advertising system, there may be a prediction algorithm (or model, program, engine, module, etc.) which may be used in, for example, given a serving opportunity, determining the probability of click, conversion, or other action or metric, for each ad in a pool of ad candidates. Some embodiments of the invention provide a fast feedback system which can give fast feedback to a prediction algorithm, program or model, resulting in advantages such as more efficient or accurate prediction, or lower prediction error. In some embodiments, the system may include the use of a central server which may collect performance data or statistics, which can include budget or spend data, in real time or near real time, and may make such data available (perhaps after aggregation), or efficiently or optimally available, such as to a prediction algorithm, program, model or system.

In ad serving, ads may be served by using a prediction model, which may predict how effective a particular ad will be for a current opportunity, for example. Significant features in such models can include past performance, such as, for example, click-through rates, conversion rates, etc. Such models may rely on a feedback mechanism which, in turn, depends on recording and aggregating performance data logs. Doing so for potentially thousands of ad servers can be very time-consuming, inefficient and fragmented. For example, delays of up to twenty four hours can occur between events and event information being made available to a prediction model. Some embodiments of the invention provide a centralized aggregation approach which can, among other things, cut latency, or feedback loop delay, dramatically, such as down to seconds or less, which can result in more accurate prediction modeling, better ad selection, and ultimately better ad performance, etc.

Some embodiments provide solutions that may incorporate a central server, which may be or include a group of servers. Techniques such as sharding can allow a computational load to be spread over a group of server computers, for example. The central sever computer, or a database thereof or accessible thereto, may maintain statistics, such as performance statistics, on all ads being served, as well as potentially other statistics relating to advertisers, advertisements or ad campaigns, such as advertiser or ad campaign budget or spend information. In some embodiments, each time an ad server serves an impression, it may update the central server in relation to this. Furthermore, each time a click (or conversion) happens, the event information is passed on to or obtained by the central server. The central server may perform, or continuously perform, aggregation on the fly, in real-time or near real time. As such, a real-time or near real time snapshot can be generated, including information relating to the performance of many ads being served. Furthermore, techniques such as sharding can allow this scheme to be effectively or efficiently scaled up.

In some embodiments, periodically, whenever a prediction model needs or is desired to be updated, a central server is queried and a performance snapshot is retrieved. This snapshot may be used in building a new, updated model. Such snapshots can be taken very frequently, which can result in a near real time feedback loop. Furthermore, in some embodiments, the snapshots can act as or like, or have advantages similar to that of, a local cache, and greatly reduce or eliminate a read load on the central server, for example.

While the invention is described with reference to the above drawings, the drawings are intended to be illustrative, and the invention contemplates other embodiments within the spirit of the invention.

1. A method comprising:
obtaining and storing, by a central server computer, or a central server computer group, online advertisement performance information from each of a plurality of advertisement server computers, wherein the performance information is sent from the advertisement server computers as individual advertisement performance event information becomes available to the advertisement server computers;
the central server computer, or the central server computer group, aggregating the performance information from the advertisement server computers as the performance information is obtained and stored by the central server computer, or the central server computer group, to generate and store aggregated performance information;
the central server computer, or the central server computer group, utilizing the aggregated performance information to generate a performance snapshot, the performance snapshot providing aggregated and updated advertisement performance information relating to performance of advertisements for which performance information was obtained by the central server computer, or the central server computer group;
a performance prediction model program obtaining and using the snapshot in updating a performance prediction model; and
using one or more computers, utilizing the updated performance prediction model in selection of advertisements to be served in response to advertisement serving opportunities, or in monitoring or reporting associated with the advertisements.

2. The method of claim 1, wherein the performance information comprises online advertising budget information.

3. The method of claim 1, wherein the performance information comprises online advertising spend information and advertising budget information, and comprising concurrent monitoring and tracking of both the spend information and the budget information.

4. The method of claim 1, wherein obtaining and storing, by a central server computer, or a central server computer group, online advertisement performance information from each of a plurality of advertisement server computers comprises obtaining the performance information in near real time relative to when individual advertisement performance event information becomes available to the server computers.

5. The method of claim 1, wherein obtaining and storing, by a central server computer, or a central server computer group, online advertisement performance information from each of a plurality of advertisement server computers comprises obtaining the performance information within less than a minute of when individual advertisement performance event information becomes available to the server computers.

6. The method of claim 1, wherein aggregating the performance information comprises manipulating, streamlining, and reducing the performance information for ease, or speed of use, or both, by the prediction model program.

7. The method of claim 1, wherein the central server computer, or the central server computer group, aggregating the performance information from the advertisement server computers as the performance information is obtained and stored by the central server computer, or central server computer group, to generate and store aggregated performance information comprises updating the aggregated performance information in near real time relative to when new performance information is obtained by the central server computer, or the central server computer group.

8. The method of claim 1, wherein the central server computer, or the central server computer group, aggregating the performance information from the advertisement server computers as the performance information is obtained and stored by the central server computer, or the central server computer group, to generate and store aggregated performance information comprises updating the aggregated performance information with a frequency of more than once per minute.

9. The method of claim 1, comprising the performance prediction model program obtaining and using the snapshot in updating the performance prediction model in near real time relative to when a new snapshot is obtained by the performance prediction model program.

10. The method of claim 1, comprising the performance prediction model program obtaining and using the snapshot in updating the performance prediction model with a frequency of more than once per minute.

11. The method of claim 1, comprising serving the selected advertisements in response to serving opportunities.

12. A system comprising:
one or more server computers coupled to a network, comprising a central server computer, or a central server computer group; and
one or more databases coupled to the one or more server computers;
wherein the one or more server computers are for:
obtaining and storing, by a central server computer of the one or more server computers, or a central server computer group of the one or more server computers, online advertisement performance information from each of a plurality of advertisement server computers, wherein the performance information is sent from the advertisement server computers as individual advertisement performance event information becomes available to the advertisement server computers;
the central server computer, or the central server computer group, aggregating the performance information from the advertisement server computers as the performance information is obtained and stored by the central server computer, or the central server computer group, to generate and store aggregated performance information;
the central server computer, or central server computer group, utilizing the aggregated performance information to generate a performance snapshot, the performance snapshot providing aggregated and updated advertisement performance information relating to performance of advertisements for which performance information was obtained by the central server computer, or the central server computer group;
a performance prediction model program obtaining and using the snapshot in updating a performance prediction model; and
utilizing the updated performance prediction model in selection of advertisements to be served in response to advertisement serving opportunities, or in monitoring or reporting associated with the advertisements.

13. The system of claim 12, wherein at least one of the one or more server computers are coupled to the Internet.

14. The system of claim 12, wherein the performance information comprises online advertising budget information.

15. The system of claim 12, wherein the performance information comprises online advertising spend information.

16. The system of claim 12, wherein obtaining and storing, by a central server computer, or a central server computer group, online advertisement performance information from each of a plurality of advertisement server computers comprises obtaining the performance information in near real time relative to when individual advertisement performance event information becomes available to the server computers.

17. The system of claim 12, wherein obtaining and storing, by a central server computer, or a central server computer group, online advertisement performance information from each of a plurality of advertisement server computers comprises obtaining the performance information within less than a minute of when individual advertisement performance event information becomes available to the server computers.

18. The system of claim 12, wherein aggregating the performance information comprises manipulating, streamlining, and reducing the performance information for ease, or speed of use, or both, by the prediction model program.

19. The system of claim 12, wherein the central server computer, or the central server computer group, aggregating the performance information from the advertisement server computers as the performance information is obtained and stored by the central server computer, or central server computer group, to generate and store aggregated performance information comprises updating the aggregated performance information in near real time relative to when new performance information is obtained by the central server computer, or the central server computer group.

20. A computer readable medium or media containing instructions for executing a method comprising:
obtaining and storing, by a central server computer, or a central server computer group, online advertisement performance information from each of a plurality of advertisement server computers, wherein the performance information is sent from the advertisement server computers as individual advertisement performance event information becomes available to the advertisement server computers;
the central server computer, or the central server computer group, aggregating the performance information from the advertisement server computers as the performance information is obtained and stored by the central server computer, or the central server computer group, to generate and store aggregated performance information;
the central server computer, or the central server computer group, utilizing the aggregated performance information to generate a performance snapshot, the performance snapshot providing aggregated and updated advertisement performance information relating to performance of advertisements for which performance information was obtained by the central server computer, or the central server computer group;
a performance prediction model program obtaining and using the snapshot in updating a performance prediction model;
using one or more computers, utilizing the updated performance prediction model in selection of advertisements to be served in response to advertisement serving opportunities;
wherein the aggregated performance information, the snapshot, and the model are repeatedly updated over time;
using one or more server computers, serving the selected advertisements in response to serving opportunities.
